(19) United States
(12) Patent Application Publication
(10) Pub. No.: US 2015/0236492 A1
(43) Pub. Date: Aug. 20, 2015

(54) Cable Clip

(71) Applicant: Mark COSTIGAN, Wallsend Tyne and Wear (GB)

(72) Inventor: Mark Costigan, Wallsend Tyne and Wear (GB)

(21) Appl. No.: 14/408,033

(22) PCT Filed: Feb. 11, 2013
(86) PCT No.: PCT/GB13/50309

§ 371 Date: Dec. 15, 2014

(30) Foreign Application Priority Data
Feb. 21, 2012 (GB) 1202946.8
Dec. 19, 2012 (GB) 1223018.1

(51) Int. Cl. H02G 3/00

(52) U.S. Cl. CPC H02G 3/26

(57) ABSTRACT

A cable clip configured to receive a plurality of cables includes a plurality of cable receiving openings each adapted to grip a cable located therein. The clip includes an upper member and a lower member, each member including a part of each of the cable receiving openings. Each part of an opening in one of the members aligns with a corresponding part of an opening in the other of the members.

### FIELD OF THE INVENTION

The present invention relates to a cable clip and in particular to a clip for holding a plurality of cables, in a particular relationship to one another.

### BACKGROUND OF THE INVENTION

The main connection point into a computer network is via network switches. Devices such as servers, storage, computers, printers and other end user devices connect to the network by the means of a network switch, typically using copper or fibre ethernet cables. End devices use a local port in the wall or floor, the building cabling is then terminated on patch panels in a communications cabinet. It is there where a vast amount of network cables are used to connect from patch panel to network switch. Also in computer data centres a multitude of network switches connect back to larger distribution or core network switches in the most commonly used network architecture model. Virtualisation is now common place in today's data centres which also means that many servers have their own network switches built in, which now increases the number of cables that need to be managed. In larger end user locations and data centres, hundreds of cables connect into network switches in each communications cabinet.

If there is a requirement to carryout work on a network switch it may be necessary to remove some or all of the cables connected to one or more sets of network switch ports. Typically, a network has accompanying documentation in which the network architecture is recorded. Sometimes a technician is tasked with replacing a particular network switch, due to failure, upgrade or some other reason. When this replacement is required, before removing the cables from the switch, each cable must be labeled. Even if the documentation is deemed to be up to date, each cable is usually checked and re-documented or a confirmation of location is recorded before removing the cable for the work to take place. This takes considerable time and usually involves two technicians, one labelling individual cables and the other checking and updating the network architecture documentation to speed up the task.

Even in a well maintained communications cabinet the vast amount of cables makes the task of removing and refitting a number of cables from and to specific configured switch ports a difficult and time consuming task. It is also common place to find that cables running into a communications cabinet do so in an untidy manner, which makes the task even more difficult and takes even more time.

Network switch ports tend to be grouped together, typically in fours or multiples of four, sixes or multiples of sixes, and eights or multiples of eight. For example, a forty eight network switch may comprise of four columns each comprising two 6 port switch modules mounted one above the other.

A cable retention clip is described in WO2008/072004. The clip comprises two separable parts. The cables are held in cable guide members in one part of the clip. The clip is designed to attach to tray.

It would be desirable to provide an improved means of securing a plurality of cables in a particular order. In particular it would be desirable to provide a means of securing a plurality of cables in a particular order with a particular spacing between the so secured cables.

The present invention seeks to provide such a device in the form of a clip.

### SUMMARY OF THE INVENTION

According to the invention, there is provided a cable clip as specified in claim 1.

Preferred features of the invention are set out in the claims dependent on claim 1, the description and the drawings.

### BRIEF DESCRIPTION OF THE DRAWINGS

In the drawings, which illustrate preferred embodiments of the invention, and are by way of example:

FIG. 1a is a schematic representation of a forty eight port copper switch/line card;

FIG. 1b is a schematic representation of a forty eight port fibre switch/line card;

FIG. 1c is a schematic representation of a twenty four port copper switch/line card;

FIG. 1d is a schematic representation of a twenty four port fibre switch/line card;

FIG. 1e is a schematic representation of a sixteen port copper switch/line card;

FIG. 1f is a schematic representation of a twelve port copper switch/line card;

FIG. 1g is a schematic representation of an eight port copper switch/line card;

FIG. 2a is a schematic representation of a cable clip according to a first embodiment of the invention;

FIG. 2b is a schematic representation of the cable clip illustrated in FIG. 2a in an open state for attachment to a group of cables;

FIG. 2c is a schematic representation of the cable clip illustrated in FIG. 2a secured with respect to the group of cables;

FIG. 3a is a schematic representation of a cable clip according to a second embodiment of the invention;

FIG. 3b is a schematic representation of the cable clip illustrated in FIG. 3a in an open state for attachment to a group of cables;

FIG. 3c is a schematic representation of the cable clip illustrated in FIG. 3a secured with respect to the group of cables;

FIG. 4a is a schematic representation of the three clips according to the first aspect of the invention connected to the cables extending from three groups of four ports;

FIG. 4b is a schematic representation of twelve clips according to the first aspect of the invention connected to the cables extending from two rows of six groups of four ports;

FIG. 4c is a schematic representation of the twelve clips according to the first aspect of the invention connected to the cables extending from two rows of six groups of four ports;

FIGS. 5a to 5d illustrate cable clips according to the first aspect of the invention configured to receive different numbers of cables;

FIGS. 6a to 6d illustrate cable clips according to a third aspect of the invention configured to receive different numbers of cables from rows of ports stacked one on top of the other;

FIGS. 7a to 7c illustrate cable clips according to the second embodiment of the invention configured to receive different numbers of cables;

FIGS. 8a and 8b illustrate a clip according to a third embodiment of the invention;

FIG. 9 illustrates a clip according to a fourth embodiment of the invention; and

FIGS. 10a and 10b illustrates a clip according to a fifth embodiment of the invention.

### DETAILED DESCRIPTION OF THE PREFERRED EMBODIMENTS

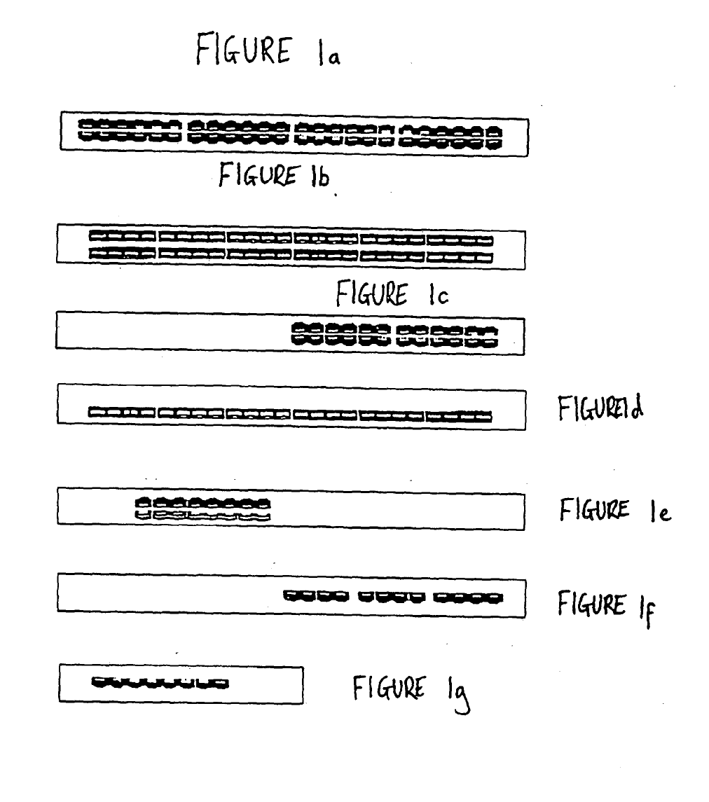

FIGS. 1a to 1g illustrate different port configurations for different types of cabling. For example, FIG. 1a illustrates a forty eight port switch/line card for copper cables, whereas FIG. 1b illustrates a forty eight port switch/line card for fibre optic cables. The respective diameters of copper and fibre optic cables differ. Also, the distance between adjacent ports differs depending on the type of wire.

It can be seen from FIGS. 1a to 1c and 1e that ports may be arranged in rows above one another.

Also, it can be seen from FIGS. 1a to 1g that ports may be grouped together in different numbers. For example, in FIG. 1b the ports are grouped together in fours, whereas in FIGS. 1a and 1c the ports are grouped together in sixes.

As will be understood by one skilled in the art of networking, that each port receives a cable, and it is essential that the correct cable is connected to the correct port due to specific configuration on each specific port.

Current methods rely on labelling individual cables and removing and replacing them one by one.

The invention seeks to provide a cable clip that allows cables to be grouped together. The invention further seeks to provide a cable clip that allows cables to be grouped together with a specific spacing between adjacent cables. The advantage of such a clip is that cables can be removed from the ports as a group and re-inserted into the ports as a group. This makes the exercise of documenting the cabling architecture much simpler since rather than each cable of the group being documented individually, a group of cables can be documented as an entity.

Also, the removal and reinsertion of the cables is made simpler, because the clip ensures that the cables are spaced apart such that if one of the cables is aligned with one of the ports, then all of the cables are aligned with all of the ports in the group.

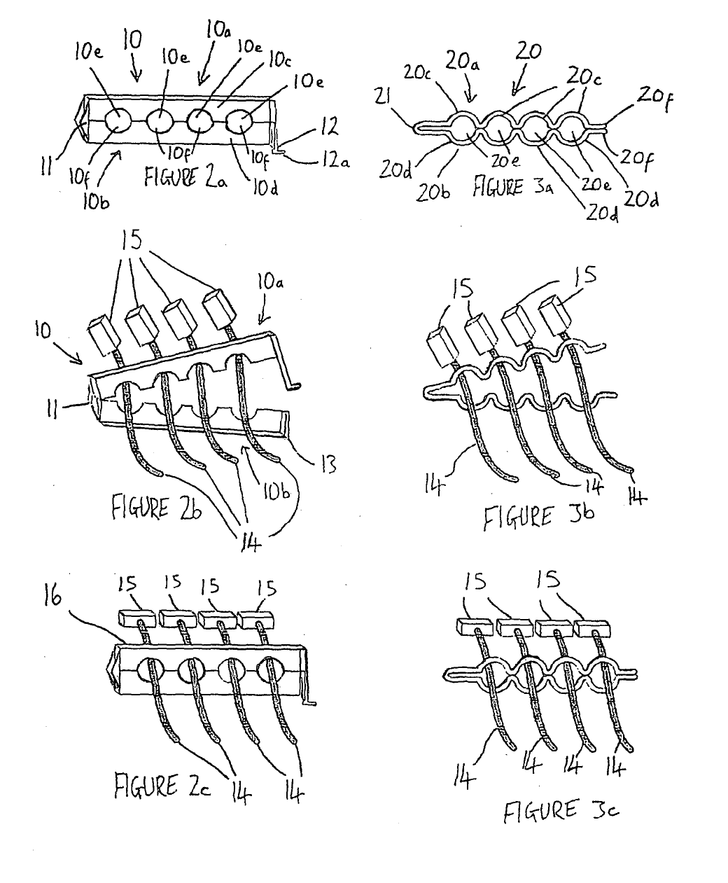

FIGS. 2a to 2c illustrate a clip 10 comprising upper and lower members 10a, 10b joined together at one end by a hinge 11, a fastener 12 is provided at the other end of the upper member 10a. The fastener 12 engages with a protrusion 13 of the lower member 10b to fasten the clip 10 closed. The fastener 12 includes a portion 12a which the user engages to prise the fastener 12 away from the protrusion 13 to allow the clip to open.

The upper and lower members 10a, 10b each include a wall 10c, 10d. Each wall 10c, 10d includes a plurality of semi-circular openings 10e, 10f, which align to form circular openings as can be appreciated from FIGS. 2a and 2c in particular.

To use the clip 10 a technician takes the clip illustrated in FIG. 2a and pulls the fastener 12 away from the protrusion 13. The hinge 11 may be sprung such that the clip is inclined to open when the fastener 12 is disengaged from the protrusion 13.

The technician then passes the open clip 10 over a group of cables 14 the ends 15 of which are connected to ports. The circular openings are spaced apart such that they will readily align with the cables, because the spacing between the centres of adjacent openings is matched to the distances between the centres of adjacent ports. There is only a relatively small number of port configurations in use, so different clips may be manufactured to match the spacings of the different port configurations.

The technician closes the clip which secures the cables in position with respect to one another. For the sake of clarity, in the Figures the cables are shown having a smaller diameter than the openings in the clips in which they lie. However, practically the openings would be sized such each cable is an interference fit in the opening. This allows the clip to grip the cable. This may be achieved by providing a compressible lining to the openings, or simply fabricating the openings such that they are of substantially the same diameter as the cable. Again, there is only a small number of different diameters of cable and hence clips may be fabricated to match the different diameters of cable used.

The clip 10 is typically formed as a single or dual piece component by moulding plastics, metal or other durable and flexible material.

The upper member 10a includes a flat surface 16. The flat surface 16 may have a label applied with an indication of the ports to which the cables are attached. Such a label may be pre-marked or the technician may write out the label as he is working.

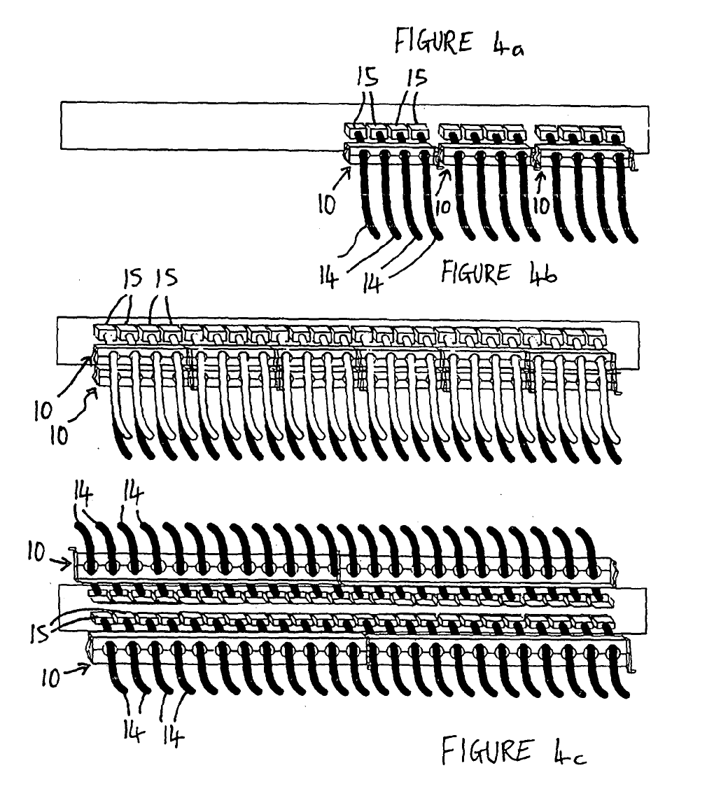

FIGS. 3a to 3c illustrate an alternative embodiment of the invention. The cable clip 20 is again formed from a single piece of plastic, metal or other durable and flexible material. The clip 20 includes an upper and lower members 20a, 20b which are joined together at a 21. The upper and lower members 20a, 20b each have an end 20f. To open the cable clip 20 the technician simply uses his fingers to push the upper and lower members 20a, 20b apart. The clip 20 may then be passed over cables 14. When the technician ceases to hold the upper and lower members 20a, 20b apart and they return to the closed configuration as shown in FIG. 3c.

The bend 21 in the clip 20 may have a label applied with an indication of the ports to which the cables are attached. Such a label may be pre-marked or the technician may write out the label as he is working.

FIGS. 4a to 4c illustrate how the cable clips of the invention may be used.

In FIG. 4a the ports are grouped together in fours in a single row. A cable clip 10 having four openings for receiving individual cables is provided.

In FIG. 4b the ports are grouped together in fours in two rows. Again, cable clips 10 having four openings for receiving individual cables are provided.

In FIG. 4c the ports are grouped together in twelves in two rows. Cable clips 10 having twelve openings for receiving individual cables are provided.

It will be appreciated from FIGS. 4b and 4c in particular that with the cables secured in clips 10 working with the cables is simpler for a technician. For example, in FIG. 4b all the cables 14 extend downward from the ports, whereas in FIG. 4c the cables attached to the upper row of cables extend upward and from the lower row downward. Moving the upper row of cables from the position shown in FIG. 4b to that shown in FIG. 4c is much simpler with the cables clipped together using the cable clips of the invention.

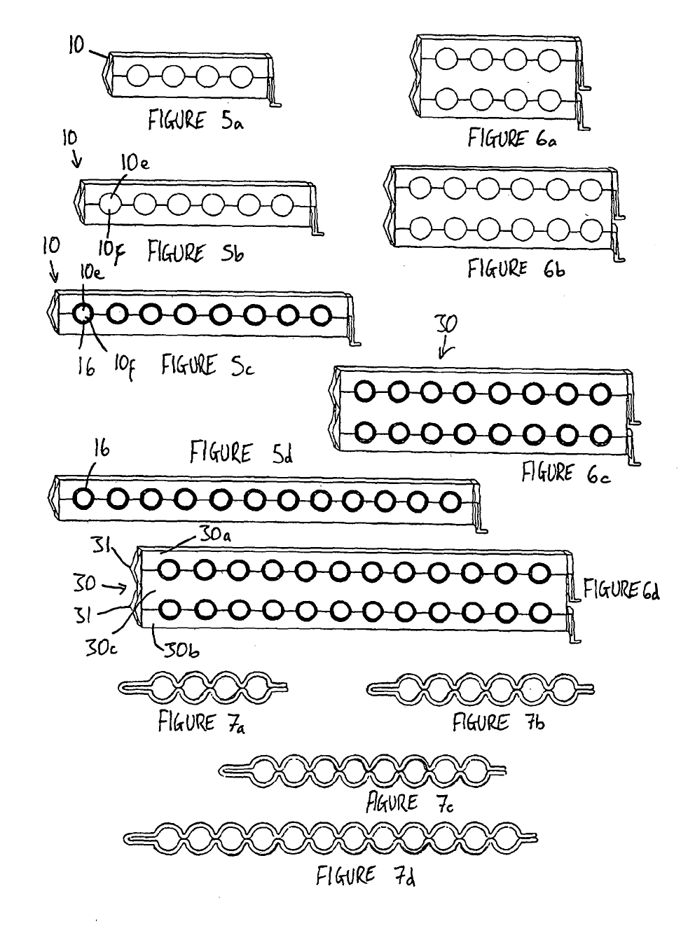

FIGS. 5 to 7 illustrate three different embodiments of cable clip and for each embodiment a number of variants in terms of the number of cables each clip can receive.

FIGS. 5a to 5c illustrate the clip 10 configured to receive four, six and eight cables respectively. In FIG. 5c, each opening is lined with a compressible material 16.

FIGS. 6a to 6d illustrate clips 30 configured to attached to cables engaged in ports arranged one row above another, with the ports grouped in fours, sixes, eights and twelves respectively.

FIGS. 7a to 7d illustrate the cable clip 20 configured to receive four, six, eight and twelve cables respectively.

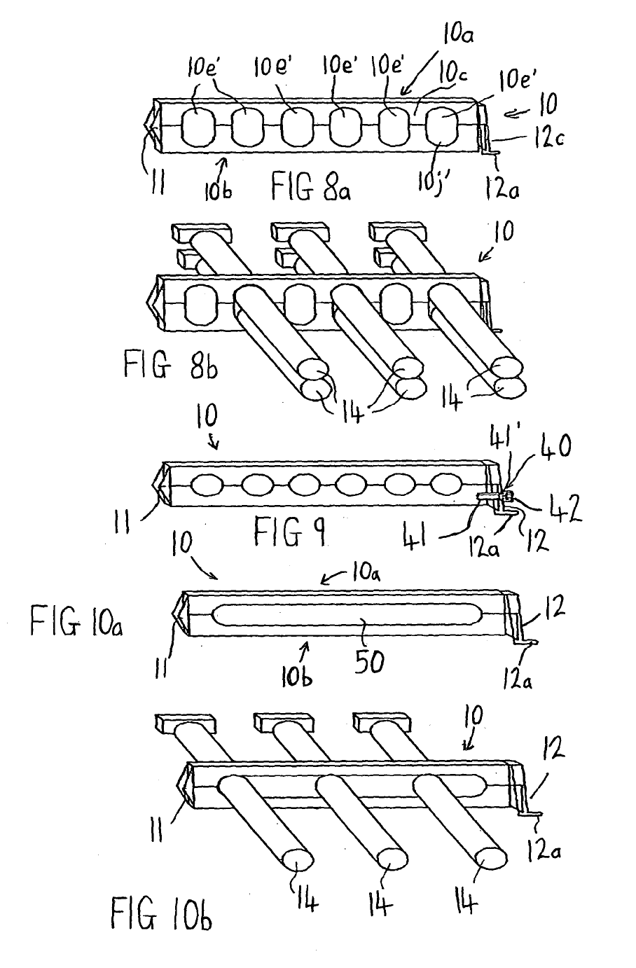

FIGS. 8a and 8b illustrate a clip 10 where the openings 10e′, 10f are U-shaped in order that an aligned pair of openings 10e′, 10f may accommodate two cables 14. By increasing the depth of the parallel sided part of the U-shaped openings 10e′, 10f a greater number of cables 14 may be accommodated within an aligned pair of openings.

FIG. 9 illustrates a further alternative clip 10 featuring a lock 40 to lock together the upper and lower members 10a, 10b. The lock 40 comprises a bore 41 in the lower member 10a and bore 41′ in the fastener 12, the bores 41, 41′ being aligned, and a screw 42. The bore 41 is threaded and receives the correspondingly threaded screw 42. The screw 42 has a head 42′ requiring a special tool to engage therewith, thereby preventing tampering with the clip 10.

FIGS. 10a and 10b illustrate a further alternative embodiment of the invention. The clip 10 illustrated in FIGS. 10a and 10b has a single shallow U-shaped opening 50 in each of the upper and lower members 10a, 10b. For ease of understanding only three cables 14 are illustrated in FIG. 10b. It can be appreciated that once the clip 10 is closed, cables 14 cannot slide past one another. Equally, the openings 50 may also be filled with cables 14, adjacent cables 14 touching one another.

The cable clip of the invention will make the task of a technician much simpler, saving time and hence cost. It will also reduce the risk of cables being inserted into incorrect ports therefore reducing errors, downtime and consequently even more time and cost.

1-18. (canceled)

19. A cable clip configured to receive a plurality of cables, the clip comprising:
elongate upper member and lower members that are joined together pivotally at respective ends thereof;
at least one cable receiving opening that is formed wholly or partially in at least one of the members and is adapted to receive and grip a cable located therein;
wherein the or each opening has an open end and a closed end.

20. A cable clip according to claim 19, wherein a part of the at least one cable receiving opening is formed in each of the upper and lower members, wherein each part of the opening in one of the members aligns with a corresponding part of an opening in the other of the members.

21. A cable clip according to claim 19, wherein the clip includes a plurality of spaced apart cable receiving openings.

22. A cable clip according to claim 19, wherein the upper and lower members each includes a flat surface extending laterally with respect to a longitudinal axis of the clip and a wall extending perpendicularly to the flat surface and towards the other of the upper and lower members, and wherein the at least one cable receiving opening are formed in a wall.

23. A cable clip according to claim 22, wherein the wall is substantially narrower than the flat surface.

24. A cable clip according to claim 19, wherein the clip further includes fastening means adapted to fasten together releasably the upper and lower members.

25. A cable clip according to claim 19, wherein the material joining the upper and lower members together allows for relative movement of the members towards and away from each other, and wherein the upper and lower members are biased towards one another.

26. A cable clip according to claim 19, wherein the upper and lower members are joined together by a hinge.

27. A cable clip according to claim 19, wherein the at least one cable receiving opening is substantially round in cross-section.

28. A cable clip according to claim 19, wherein the at least one opening in at least one of the upper and lower members is substantially U-shaped.

29. A cable clip according to claim 19, wherein the at least one cable receiving opening is lined with a compressible material.

30. A cable clip according to claim 19, wherein the clip includes upper, lower and central members, the clip providing two rows cable receiving openings, wherein the upper member and the central member each include a part of each opening in the upper row of openings, and wherein the lower member and the central member each include a part of each opening in the lower row of openings, wherein each part of an opening in one of the upper and lower members aligns with a corresponding part of an opening in the central member.

31. A cable clip according to claim 30, wherein the upper member and the central member and the lower member and the central member are joined together at one end thereof.

32. A cable clip according to claim 31, wherein the upper and central members and the lower and central members are joined together by respective hinges.

33. A cable clip according to claim 32, wherein the material joining the upper and central and lower and central members together allows for relative movement of the members towards and away from each other, and wherein the upper and lower members are biased towards the central member.

34. A cable clip according to claim 19, wherein a space between centers of adjacent openings corresponds to a space between centers of adjacent cable receiving ports.

35. A cable clip according to claim 19, further including a lock configured to lock the clip in a closed configuration.
